(19) United States
(12) Patent Application Publication
(10) Pub. No.: US 2019/0093873 A1
(43) Pub. Date: Mar. 28, 2019

(54) MOVING-BODY LIGHTING DEVICE AND MOVING BODY

(71) Applicant: PANASONIC INTELLECTUAL PROPERTY MANAGEMENT CO., LTD., Osaka (JP)

(72) Inventor: Tetsuya NISHI, Osaka (JP)

(73) Assignee: PANASONIC INTELLECTUAL PROPERTY MANAGEMENT CO., LTD., Osaka (JP)

(21) Appl. No.: 16/141,267

(22) Filed: Sep. 25, 2018

(30) Foreign Application Priority Data
Sep. 27, 2017 (JP) 2017-187031

(51) Int. Cl. F21V 29/74; F21S 41/275; F21S 41/24; F21S 41/32; F21S 41/692

(52) U.S. Cl. CPC F21V 29/74; F21S 41/275; F21Y 2115/10; F21S 41/321; F21S 41/692; F21S 41/24

(57) ABSTRACT

A moving-body lighting device includes: a first light source; a second light source that is disposed forward of the first light source and emits light forward; a reflector in a shape of a segment of a spheroid, and that reflects the light emitted by the first light source; a projection lens that receives the light emitted by the first light source and reflected by the reflector; and a shade disposed between the second light source and the projection lens, proximate a second focal point. The projection lens includes a first lens region that receives the light emitted by the first light source and reflected by the reflector, and a second lens region that receives the light emitted by the second light source. The major axis of the spheroid is oblique to a horizontal axis.

### CROSS REFERENCE TO RELATED APPLICATION

This application claims the benefit of priority of Japanese Patent Application Number 2017-187031 filed on Sep. 27, 2017, the entire content of which is hereby incorporated by reference.

### BACKGROUND

### 1. Technical Field

The present disclosure relates to a moving-body lighting device and a moving body.

### 2. Description of the Related Art

A lighting device for use in a vehicle that emits light forward and includes a first light-emitting device for generating a high beam that is mounted toward an edge of a substrate, a second light-emitting device for generating a low beam, and a lens body disposed forward of the first and second light-emitting devices is known (for example, see Japanese Unexamined Patent Application Publication No. 2015-216019).

### SUMMARY

In the vehicle lighting device disclosed in Japanese Unexamined Patent Application Publication No. 2015-216019, when a single, common heat sink is used for the first heat sink attached to the first light-emitting device and the second heat sink attached to the second light-emitting device, and a single, common lens body is used for the first and second light-emitting devices, it is conceivable that the first light-emitting device for generating the high beam will be disposed proximate the second light-emitting device. This is because the high beam illuminates a region above the region illuminated the low beam. In such cases, since the first and second light-emitting devices are disposed proximate a corner of the region of the common heat sink corresponding to the first heat sink, it is difficult to ensure sufficient design freedom.

In view of this, the present disclosure has an object to provide a moving-body lighting device and a moving body that can ensure sufficient design freedom.

In order to achieve the object described above, a moving-body lighting device according to one aspect of the present disclosure is configured to be used in a moving body, and includes: a first light source that emits light; a second light source that is disposed forward of the first light source and emits light forward; a reflector in a shape of a segment of a spheroid having a first focal point proximate the first light source and a second focal point, and that reflects the light emitted by the first light source; a projection lens that is disposed forward of the second light source and receives the light emitted by the first light source and reflected by the reflector; and a shield disposed between the second light source and the projection lens, proximate the second focal point. The shield includes an edge region including a step, the edge region blocking a portion of the light reflected by the reflector and transmitting a remaining portion of the light to the projection lens. The projection lens includes a first lens region that receives the light emitted by the first light source and reflected by the reflector, and a second lens region that receives the light emitted by the second light source. The major axis of the spheroid is oblique to the horizontal axis in an installation position of the moving-body lighting device in the moving body.

A moving body according to one aspect of the present disclosure includes a moving-body lighting device used in a headlight.

With the present disclosure, it is possible to ensure sufficient design freedom.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 schematically illustrates a vehicle according to Embodiment 1;

FIG. 2 is a cross-sectional view of a moving-body lighting device according to Embodiment 1, taken at line II-II in FIG. 1;

FIG. 3 is an enlarged perspective view of a shade in the moving-body lighting device according to Embodiment 1;

FIG. 4 is a cross-sectional view schematically illustrating paths of light in the moving-body lighting device according to Embodiment 1;

FIG. 5 is a cross-sectional view of a moving-body lighting device according to a comparative example;

FIG. 6 is a cross-sectional view schematically illustrating paths of light in the moving-body lighting device according to the comparative example;

FIG. 7 is a cross-sectional view of a moving-body lighting device according to Embodiment 2; and

FIG. 8 is a perspective view of a reflective tube in the moving-body lighting device according to Embodiment 2.

### DETAILED DESCRIPTION OF THE EMBODIMENTS

The following describes embodiments with reference to the drawings. The embodiments described below each show a preferred, specific example of the present disclosure. The numerical values, shapes, materials, elements, the arrangement and connection of the elements, etc., indicated in the following embodiments are mere examples, and therefore do not intend to limit the present disclosure. Therefore, among elements in the following embodiments, those not recited in any of the broadest, independent claims are described as optional elements.

Moreover, “approximately” means, for example in the case of “approximately the same”, not only exactly the same, but what would be recognized as essentially the same as well. Furthermore, “proximate” means, for example in the case of “proximate X”, in contact with X or within several centimeters of X.

Note that the drawings are represented schematically and are not necessarily precise illustrations. Additionally, like reference signs indicate like elements in the drawings, and repeated descriptions thereof are omitted or simplified.

Hereinafter, embodiments of a moving-body lighting device and a moving body according to the present disclosure will be described.

### Embodiment 1

### (Configuration)

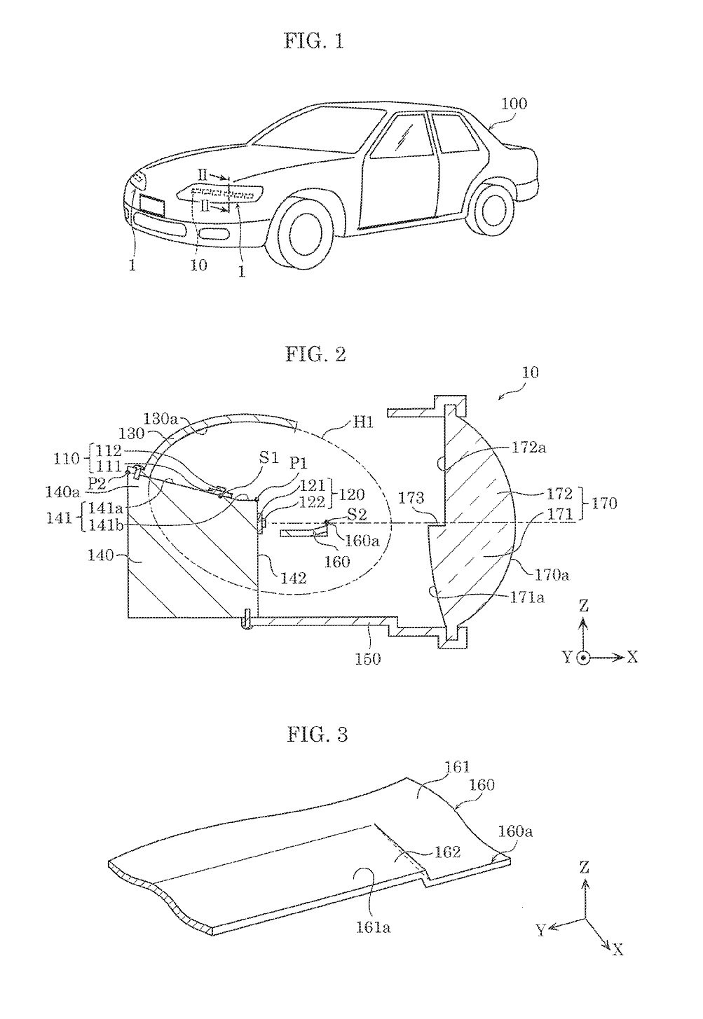

FIG. 1 schematically illustrates vehicle 100 according to Embodiment 1.

X, Y, and Z directions are shown in FIG. 2. The direction in which moving-body lighting device 10 emits light corresponds to the X axis positive direction, the direction pointing upward out of the drawing corresponds to the Y axis positive direction, and the direction in which first light source 110 emits light corresponds to the Z axis positive direction. The directions shown in FIG. 2 correspond to the directions shown in FIG. 3. This also applies to the drawings subsequent to FIG. 3, excluding the drawings in which the X, Y, and Z directions are not indicated.

As illustrated in FIG. 1, moving-body lighting device 10 is used in vehicle 100, and, more specifically, is included in headlight 1 of vehicle 100. Moving-body lighting device 10 is electrically connected to the electric system in vehicle 100. Vehicle 100 is one example of the moving body.

FIG. 2 is a cross-sectional view of moving-body lighting device 10 according to Embodiment 1, taken at line II-II in FIG. 1. FIG. 2 only illustrates a cross section.

As illustrated in FIG. 2, moving-body lighting device 10 is a module used in vehicle 100. Moving-body lighting device 10 includes first light source 110, reflector 130, second light source 120, heat dissipator 140, holding component 150, shade 160, and projection lens 170.

First light source 110 includes first substrate 111 and first light-emitting device 112.

First substrate 111 is a mounting substrate for mounting first light-emitting device 112, and is, for example, a ceramics substrate, resin substrate, or metal-based substrate coated with an electrical insulation film. In this embodiment, first substrate 111 is a low temperature co-fired ceramics (LTCC) package substrate. For example, first substrate 111 is a plate-shaped substrate having a flat surface with a rectangular plan-view shape.

First light-emitting device 112 is mounted on first substrate 111. First substrate 111 is fixed to first surface 141 of heat dissipator 140 (to be described later) at an incline relative to the X axis so as to slope downward in the X axis positive direction.

First light-emitting device 112 emits light. In this embodiment, since first substrate 111 is disposed at an incline on heat dissipator 140, first light-emitting device 112 emits light angled toward the X axis positive direction from the Z axis positive direction. The Z axis positive direction is one example of the vertical upward direction. First light-emitting device 112 is disposed a predetermined distance from first edge P1 of sloped surface 141a of first surface 141.

First light-emitting device 112 is a light source that emits light to be projected from moving-body lighting device 10. In this embodiment, first light-emitting device 112 is a light emitting diode (LED) light source, which is a light-emitting module including an LED, that radially emits predetermined light. For example, first light-emitting device 112 is configured so as to emit white light. First light-emitting device 112 is, for example, an LED chip mounted on first substrate 111 and including a flip chip LED. A plurality of first light-emitting devices 112 may be mounted on first substrate 111.

The X axis negative direction end of reflector 130 is attached to the X axis negative direction end of heat dissipator 140 via a fastener such as a screw. The X axis negative direction end of reflector 130 is located further in the X axis negative direction than first light source 110 and further in the Z axis positive direction than first light source 110. The X axis negative direction end of reflector 130 is in contact with second edge P2. Stated differently, the X axis negative direction end of reflector 130 is located proximate the peak of heat dissipator 140. The X axis negative direction is one example of “rear”.

Reflector 130 is disposed further in the Z axis positive direction than first light source 110. Curved reflective surface 130a of reflector 130 that opposes first light source 110 has a mirror finish. Curved reflective surface 130a of reflector 130 reflects light emitted in the Z axis positive direction by first light source 110, so as to be incident on projection lens 170. Curved reflective surface 130a of reflector 130 has a prescribed curvature. For example, the reflectivity of curved reflective surface 130a of reflector 130 may be achieved by forming a metal deposition film such as an aluminum deposition film on curved reflective surface 130a of reflector 130.

Reflector 130 is in a shape of a segment of spheroid H1 having first focal point S1 that is proximate first light source 110 and second focal point S2 that is proximate shade 160. Reflector 130 reflects the light emitted by first light source 110 toward projection lens 170 disposed further in the X axis positive direction than first light source 110. The major axis of spheroid H1 formed by reflector 130 is oblique to the X axis in an installation position of moving-body lighting device 10 in vehicle 100. First focal point S1 and second focal point S2 are foci of an elliptical cross section of spheroid H1 in the XZ plane. Second focal point S2 is located further in the X axis positive direction than first focal point S1. Spheroid H1 has an imaginary curved surface, and curved reflective surface 130a matches a segment of the imaginary curved surface. The X axis is one example of the horizontal axis. The Z axis is one example of the vertical axis.

More specifically, in this embodiment, in a cross-sectional view of curved reflective surface 130a of reflector 130, curved reflective surface 130a is in a shape of a segment of an approximate ellipse indicated by the long-dash double short-dashed line in the drawings. The major axis of the approximate ellipse indicated by the long-dash double short-dashed line is oblique to the X axis so as to slope downward in the X axis positive direction. First light source 110 is disposed proximate first focal point S1 of the approximate ellipse formed by reflector 130. Shade 160 is disposed proximate second focal point S2 of the approximate ellipse formed by reflector 130.

Second light source 120 includes second substrate 121 and second light-emitting device 122.

Second substrate 121 is a mounting substrate for mounting second light-emitting device 122, and is, for example, a ceramic substrate, resin substrate, or metal-based substrate coated with an electrically insulating film. In this embodiment, second substrate 121 is an LTCC package substrate. For example, second substrate 121 is a plate-shaped substrate having a flat surface with a rectangular plan-view shape.

Second light-emitting device 122 is mounted on second substrate 121. Second substrate 121 is fixed to second surface 142 of heat dissipator 140, located in the X axis positive direction of heat dissipator 140.

Second light-emitting device 122 of second light source 120 is disposed further in the X axis positive direction than first light-emitting device 112 of first light source 110, and emits light in the X axis positive direction. In this embodiment, second light-emitting device 122 faces and emits light in the X axis positive direction. The X axis positive direction corresponds to “forward”, and also corresponds to the forward direction of travel of vehicle 100.

Second light-emitting device 122 is disposed further in the Z axis negative direction than first light source 110 and further in the Z axis positive direction than shade 160. Second light-emitting device 122 is disposed a predetermined distance from first edge P1 on second surface 142. The Z axis negative direction is one example of the vertical downward direction.

Second light-emitting device 122 is a light source that emits light to be projected from moving-body lighting device 10. In this embodiment, second light-emitting device 122 is an LED light source, which is a light-emitting module including an LED, that radially emits predetermined light. For example, second light-emitting device 122 is configured so as to emit white light.

Second light-emitting device 122 is, for example, an LED chip mounted on second substrate 121 and including a flip chip LED. A plurality of second light-emitting devices 122 may be mounted on second substrate 121.

Heat dissipator 140 is a pedestal that holds first substrate 111 and second substrate 121. Heat dissipator 140 is an approximate cuboid. Heat dissipator 140 has a heat dissipating structure that dissipates heat generated by first light-emitting device 112 and second light-emitting device 122. The heat dissipating structure is a heat sink including a plurality of fins.

Heat dissipator 140 includes first surface 141 on which first light source 110 is disposed, second surface 142 on which second light source 120 is disposed, first edge P1 at which first surface 141 and second surface 142 intersect, and second edge P2 across first surface 141 from first edge P1. Heat dissipator 140 is thermally connected to first light source 110 and second light source 120.

First surface 141 includes sloped surface 141a and planar surface 141b. Sloped surface 141a is oblique to the X axis so as to slope downward in the X axis positive direction. Planar surface 141b is continuous with sloped surface 141a. First light source 110 is disposed on sloped surface 141a. First surface 141 is located in the Z axis positive direction of heat dissipator 140. Planar surface 141b is located on the X axis positive direction side of sloped surface 141a. Planar surface 141b is parallel to the XY plane, and is angled relative to second surface 142.

First surface 141 is in contact with the X axis negative direction end of reflector 130. In other words, heat dissipator 140 is thermally connected to reflector 130.

Heat dissipator 140 includes protrusion 140a on first surface 141. Protrusion 140a includes sloped surface 141a, which is part of first surface 141. Protrusion 140a protrudes in the Z axis positive direction relative to planar surface 141b. The Z axis positive direction peak of protrusion 140a is second edge P2.

Second surface 142 is approximately parallel to the Z axis. Second surface 142 is located at the X axis positive direction end of heat dissipator 140, and is angled relative to first surface 141. Second substrate 121 is fixed to second surface 142.

Holding component 150 is, for example, a tubular enclosure. Holding component 150 internally defines a front opening located at the X axis positive end through which light emitted by first light-emitting device 112 and second light-emitting device 122 passes. Holding component 150 is fixed to heat dissipator 140 via a fastener such as a bolt inserted into a threaded hole.

Projection lens 170 is disposed further in the X axis positive direction than second light source 120 and receives light emitted by first light source 110 and reflected by reflector 130. Projection lens 170 has one convex surface and is light transmissive. The surface on the X axis positive side of projection lens 170 curves so as to protrude, and the surface on the X axis negative side includes a planar surface. Projection lens 170 is disposed on the X axis positive end of holding component 150 and covers the front opening of holding component 150. Projection lens 170 receives the light emitted by first light-emitting device 112 and second light-emitting device 122 after it travels through the inside of holding component 150.

Projection lens 170 includes first lens region 171 that receives light emitted by first light source 110 and reflected by reflector 130 and second lens region 172 that receives light emitted by second light source 120.

First lens region 171 is disposed further in the Z axis negative direction than second lens region 172 and further in the Z axis negative direction than edge region 160a. The focal point of first lens region 171 is located proximate the cutoff line defined by shade 160.

First lens region 171 is integral with second lens region 172. First lens region 171 is a biconvex lens. First lens region 171 includes first entrance surface 171a and emission surface 170a. First entrance surface 171a is a curved surface on the X axis negative side, and is the surface that receives light from first light source 110. Emission surface 170a is a curved surface on X axis positive side, and is the surface through which the light received via first entrance surface 171a exits first lens region 171. In this embodiment, the radius of curvature of first entrance surface 171a of first lens region 171 is smaller than the radius of curvature of emission surface 170a of first lens region 171.

Second lens region 172 is a piano-convex lens. Second lens region 172 includes second entrance surface 172a and emission surface 170a. Second entrance surface 172a is a planar surface on the X axis negative side, and is the surface that receives light from second light source 120. Emission surface 170a of second lens region 172 is a curved surface flush with emission surface 170a of first lens region 171. Accordingly, the light received via second entrance surface 172a exits from emission surface 170a of second lens region 172.

The focal point of second lens region 172 is located proximate second light source 120.

FIG. 3 is an enlarged perspective view of shade 160 in moving-body lighting device 10 according to Embodiment 1.

As illustrated in FIG. 2 and FIG. 3, shade 160 is disposed between second light source 120 and projection lens 170, proximate second focal point S2. Shade 160 blocks a portion of the light emitted by first light-emitting device 112 and second light-emitting device 122. Shade 160 has the shape of a plate, and is made of a resin material or metal material, for example. Shade 160 blocks a portion of the light such that the light distribution pattern of headlight 1 is in accordance with the law. The shape of shade 160 may be changed as necessary in order to form part of the light distribution pattern. Shade 160 is one example of the shield.

As illustrated in FIG. 3, shade 160 includes flat region 161, sloped step region 162, and edge region 160a.

Flat region 161 is approximately parallel to the XY plane. Sloped step region 162 defines a step in part of shade 160 that protrudes in the Z axis positive direction from flat region 161. Sloped step region 162 includes sloped surface 161a that slopes upward in the X axis positive direction. Edge region 160a is the edge of shade 160 located at the X axis positive direction and Z axis positive direction end, and is defined by the edges of flat region 161 and sloped step region 162. Here, edge region 160a has a stepped region. The stepped region corresponds to sloped step region 162. Edge region 160a blocks a portion of the light reflected by reflector 130 and transmits the remaining portion of the light to projection lens 170 so as to give headlight 1 a light distribution pattern that is in accordance with law. Note that the surfaces of flat region 161 and sloped step region 162 located in the Z axis positive direction may function to diffuse light.

In moving-body lighting device 10, first light source 110, second light source 120, edge region 160a, and boundary 173 between second lens region 172 and first lens region 171 are arranged in the listed order from top to bottom in the Z axis negative direction.

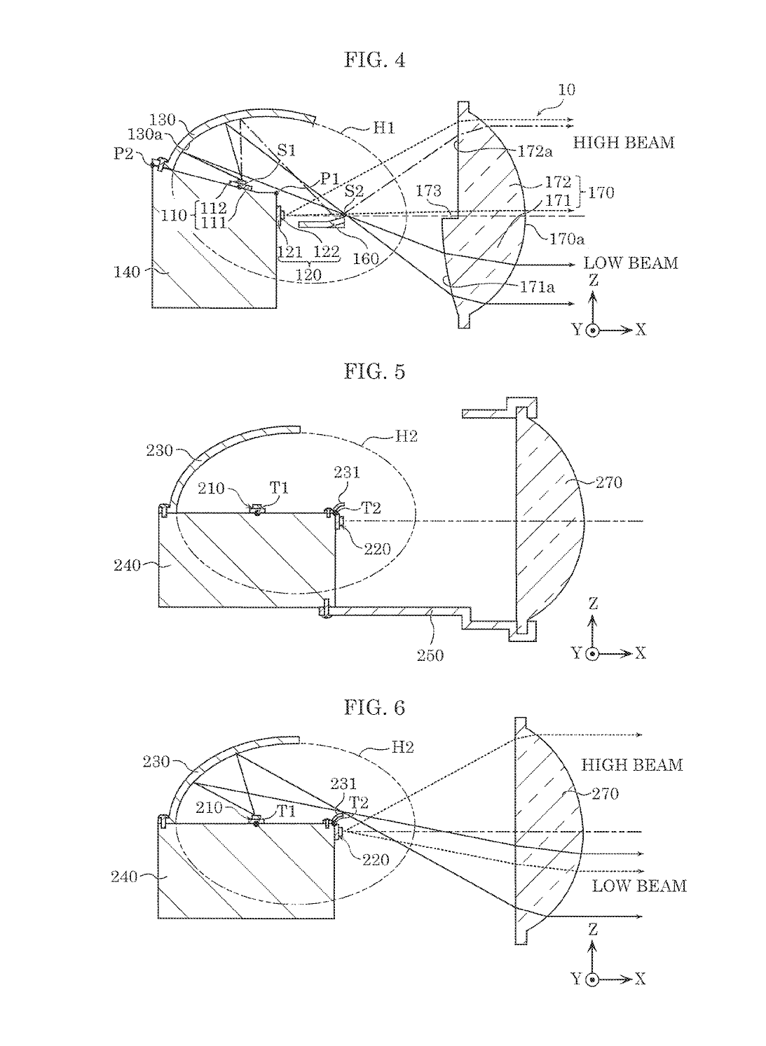

FIG. 4 is a cross-sectional view schematically illustrating paths of light in moving-body lighting device 10 according to Embodiment 1. FIG. 4 only illustrates a cross section.

As illustrated in FIG. 4, with moving-body lighting device 10 and vehicle 100, the light emitted by first light source 110 is incident on curved reflective surface 130a of reflector 130. The light incident on curved reflective surface 130a of reflector 130 is reflected by curved reflective surface 130a of reflector 130 and subsequently incident on first entrance surface 171a of first lens region 171 in projection lens 170. Here, some of the light reflected by curved reflective surface 130a of reflector 130 is blocked by shade 160. The light incident on first entrance surface 171a of first lens region 171 is the light not blocked by shade 160. The light incident on first entrance surface 171a of first lens region 171 travels through first lens region 171 and exits first lens region 171 through emission surface 170a.

Moreover, the light emitted by first light source 110 and reflected by reflector 130 may be further reflected by, for example, flat region 161 of shade 160 and used as light distributed for overhead lighting. Such distributed light is indicated with the long-dash and single-dotted line in FIG. 4

The light emitted by second light source 120 is incident on second entrance surface 172a of second lens region 172. Here, a portion of the light emitted by second light source 120 is reflected by shade 160 and then incident on second entrance surface 172a of second lens region 172. The light incident on second entrance surface 172a of second lens region 172 travels through second lens region 172 and exits second lens region 172 through emission surface 170a.

### Comparative Example

Next, a moving-body lighting device according to a comparative example will be described.

FIG. 5 is a cross-sectional view of a moving-body lighting device according to a comparative example. FIG. 6 is a cross-sectional view schematically illustrating paths of light in the moving-body lighting device according to the comparative example. FIG. 5 and FIG. 6 only illustrate cross sections.

As illustrated in FIG. 5, in the comparative example, heat dissipator 240 is an approximate cuboid, and unlike the embodiment illustrated in FIG. 2, does not include sloped surface 141a. The first surface of heat dissipator 240 is approximately parallel to the XY plane. Reflector 230 is fixed to the first surface, and the major axis of spheroid H2 formed in part by reflector 230 is approximately parallel to the X axis.

Projection lens 270 is a piano-convex lens whose convex surface is on the X axis positive direction side, and has plane symmetry about an XY plane.

Second light source 220 is disposed proximate second focal point T2. Reflector 231 is also disposed proximate second focal point T2. Reflector 231 reflects light emitted by second light source 220 so as to be incident on projection lens 270. Reflector 231 also has a function of blocking a portion of the light emitted by first light source 210 and reflected by reflector 231 and transmits the remaining portion of the light to projection lens 270. In other words, reflector 231 defines a cutoff line in the light emitted by first light source 210 and reflected by reflector 230.

With the moving-body lighting device according to this comparative example, the light emitted by first light source 210 is reflected by reflector 230, partially blocked by reflector 231, and partially transmitted so as to be incident on the Z axis negative direction side of projection lens 270. On the other hand, light emitted by second light source 220 is partially blocked by reflector 231 and partially transmitted so as to be incident on the Z axis positive direction half of projection lens 270. With the moving-body lighting device according to the comparative example, in order for the light emitted by second light source 220 to be incident on the Z axis positive direction half of projection lens 270, second light source 220 must be disposed on the Z axis positive side of heat dissipator 240, thereby making it impossible to secure sufficient design freedom.

Moreover, with the moving-body lighting device according to the comparative example, there is no shade disposed on the X axis positive direction side of second light source 220. Accordingly, in the central region of projection lens 270, the light emitted by second light source 220 mixes with the light emitted by first light source 210 and reflected by reflector 230. As a result, sufficient selective regional lighting cannot be achieved with the moving-body lighting device according to the comparative example.

Furthermore, with the moving-body lighting device according to the comparative example, since reflector 231 is disposed proximate second light source 220, a highly heat resistant reflector is required. This increases manufacturing costs for the moving-body lighting device according to the comparative example.

### (Operational Advantages)

Next, operational advantages of moving-body lighting device 10 and vehicle 100 according to this embodiment will be described.

As described above, moving-body lighting device 10 according to this embodiment is configured to be used in vehicle 100, and includes: first light source 110 that emits light; second light source 120 that is disposed in the X axis positive direction of first light source 110 and emits light in the X axis positive direction; reflector 130 in a shape of a segment of spheroid H1 having first focal point S1 proximate first light source 110 and second focal point S2, and that reflects the light emitted by first light source 110; projection lens 170 that is disposed in the X axis positive direction of second light source 120 and receives the light emitted by first light source 110 and reflected by reflector 130; and shade 160 disposed between second light source 120 and projection lens 170, proximate second focal point S2. Shade 160 includes edge region 160a including a step. Edge region 160a blocks a portion of the light reflected by reflector 130 and transmits the remaining portion of the light to projection lens 170. Projection lens 170 includes first lens region 171 that receives the light emitted by first light source 110 and reflected by reflector 130, and second lens region 172 that receives the light emitted by second light source 120. The major axis of spheroid H1 is oblique to the X axis in an installation position of moving-body lighting device 10 in vehicle 100.

In this way, shade 160 is disposed between second light source 120 and projection lens 170, and second focal point S2 of spheroid H1 is located proximate second focal point S2. Projection lens 170 includes first lens region 171 that receives light emitted by first light source 110 and reflected by reflector 130 and second lens region 172 that receives light emitted by second light source 120. The major axis of spheroid H1 formed in part by reflector 130 is oblique to the X axis. When second focal point S2 is located below first focal point S1, second light source 120 according to this embodiment can be disposed further in the Z axis negative direction than second light source 120 according to the comparative example can be. Accordingly, the design freedom with respect to second light source 120 can be increased.

Thus, with moving-body lighting device 10, it is possible to ensure sufficient design freedom.

Vehicle 100 according to this embodiment includes: headlight 1; and a moving-body light installed in headlight 1. The moving-body light includes: first light source 110 that emits light; second light source 120 that is disposed forward of first light source 110 and emits light forward; reflector 130 in a shape of a segment of a spheroid H1 having first focal point S1 proximate first light source 110 and second focal point S2, and that reflects the light emitted by first light source 110; projection lens 170 that is disposed forward of second light source 120 and receives the light emitted by first light source 110 and reflected by reflector 130; and shade 160 disposed between second light source 120 and projection lens 170, proximate second focal point S2. Shade 160 includes an edge region 160a including a step, edge region 160a blocking a portion of the light reflected by reflector 130 and transmitting a remaining portion of the light to projection lens 170. Projection lens 170 includes first lens region 171 that receives the light emitted by first light source 110 and reflected by reflector 130, and second lens region 172 that receives the light emitted by second light source 120. The major axis of spheroid H1 is oblique to a horizontal axis.

In vehicle 100 as well, the operational effects described above are achieved.

In moving-body lighting device 10 according to this embodiment, in the installation location, second light source 120 is disposed further in the Z axis negative direction than first light source 110 and further in the Z axis positive direction than shade 160.

In this way, second light source 120 is disposed further in the Z axis negative direction than first light source 110 and further in the Z axis positive direction than shade 160. Accordingly, light emitted by second light source 120 is less likely to be blocked by shade 160. Thus, light emitted by second light source 120 can be introduced into second lens region 172.

Shade 160 is disposed further in the Z axis negative direction and X axis positive direction than second light source 120. Accordingly, light emitted by second light source 120 is less likely to be incident on second lens region 172 of projection lens 170.

In moving-body lighting device 10 according to this embodiment, in the installation location, first lens region 171 is disposed further in the Z axis negative direction than second lens region 172 and further in the Z axis negative direction than edge region 160a.

In this way, first lens region 171 is disposed further in the Z axis negative direction than second lens region 172 and further in the Z axis negative direction than edge region 160a. Accordingly, the light reflected by reflector 130 is incident on first lens region 171 after being partially blocked by edge region 160a of shade 160. Thus, with moving-body lighting device 10, it is possible to emit partially blocked light that forms a light distribution pattern of headlight 1 that is in accordance with the law.

In moving-body lighting device 10 according to this embodiment, in the installation location, first light source 110, second light source 120, edge region 160a, and boundary 173 between second lens region 172 and first lens region 171 are arranged in the listed order from top to bottom in the Z axis negative direction.

In this way, first light source 110, second light source 120, edge region 160a, and boundary 173 between second lens region 172 and first lens region 171 are arranged in moving-body lighting device 10 in the listed order from top to bottom in the Z axis negative direction. For example, light emitted by first light source 110 is less likely to be blocked by, for example, second light source 120 disposed further in the X axis positive direction than first light source 110, making it possible to obtain a desired light distribution pattern.

The moving-body lighting device 10 according to the present embodiment further includes heat dissipator 140 including first surface 141 on which first light source 110 is disposed and second surface 142 on which second light source 120 is disposed. Heat dissipator 140 is thermally connected to first light source 110 and second light source 120. Heat dissipator 140 includes first edge P1 at which first surface 141 and second surface 142 intersect. Second light source 120 is disposed a predetermined distance from first edge P1 on second surface 142.

In this way, on heat dissipator 140, first light source 110 is disposed on first surface 141, and second light source 120 is disposed on second surface 142 at a predetermined distance from first edge P1. Accordingly, second light source 120 and first light source 110 are spaced apart. This makes it possible for heat dissipator 140 to more certainly dissipate heat generated by first light source 110 and second light source 120.

In moving-body lighting device 10 according to this embodiment, in the installation location, the X axis negative direction end of reflector 130 is located further in the X axis negative direction than first light source 110 and further in the Z axis positive direction than first light source 110.

With this, the X axis negative direction end of reflector 130 is located further in the X axis negative direction than first light source 110 and further in the Z axis positive direction than first light source 110. For example, compared to when the first light source and the reflector are aligned in a direction parallel to the X axis, with moving-body lighting device 10 according to this embodiment, light emitted by first light source 110 is more easily directed in the Z axis negative direction due to reflector 130. Accordingly, light emitted by first light source 110 is more likely to be reflected by reflector 130 and incident on first lens region 171 of projection lens 170. In other words, by disposing the X axis negative direction end of reflector 130 further in the X axis negative direction than first light source 110, light reflected by reflector 130 can be controlled so as to be incident on second lens region 172.

In moving-body lighting device 10 according to this embodiment, heat dissipator 140 includes protrusion 140a on first surface 141. Protrusion 140a includes sloped surface 141a that is oblique to the X axis so as to slope downward in the X axis positive direction. First light source 110 is disposed on sloped surface 141a.

In this way, first light source 110 is disposed on sloped surface 141a. Compared to heat dissipator 240 according to the comparative example, protrusion 140a allows for more heat dissipating fins to be disposed on heat dissipator 140. Accordingly, heat dissipator 140 can more reliably dissipate at least the heat generated by first light source 110.

In moving-body lighting device 10 according to this embodiment, heat dissipator 140 is an approximate cuboid. Heat dissipator 140 includes second edge P2 across first surface 141 from first edge P1. The X axis negative direction end of reflector 130 is in contact with second edge P2.

With this, the X axis negative direction end of reflector 130 is in contact with second edge P2. Accordingly, it is easier to position reflector 130 relative to heat dissipator 140 when attaching reflector 130 to heat dissipator 140.

In moving-body lighting device 10 according to this embodiment, first light source 110 is disposed a predetermined distance from first edge P1 on sloped surface 141a.

In moving-body lighting device 10 according to this embodiment, first light source 110 is disposed proximate first focal point S1, and in the installation location, first focal point S1 is located further in the Z axis positive direction than second focal point S2.

In moving-body lighting device 10 according to this embodiment, edge region 160a is disposed proximate second focal point S2.

Moving-body lighting device 10 according to this embodiment is configured to be used in vehicle 100 and includes: first light source 110 that emits light; reflector 130 that reflects the light emitted by first light source 110; second light source 120 that is disposed further in the X axis positive direction than first light source 110 and emits light in the X axis positive direction; projection lens 170 that is disposed further in the X axis positive direction than second light source 120 and reflector 130, and receives the light emitted by first light source 110 and reflected by reflector 130, and the light emitted by second light source 120; and shade 160 disposed between second light source 120 and projection lens 170. Reflector 130 is in a shape of a segment of spheroid H1 having first focal point S1 and second focal point S2. First light source 110 is disposed proximate first focal point S1. Shade 160 is disposed proximate second focal point S2. Shade 160 includes edge region 160a including a step. Edge region 160a blocks a portion of the light reflected by reflector 130 and transmits the remaining portion of the light to projection lens 170. Projection lens 170 includes first lens region 171 that receives the light emitted by first light source 110 and reflected by reflector 130, and second lens region 172 that receives the light emitted by second light source 120. The major axis of spheroid H1 intersects the X axis in the installation location.

### Embodiment 2

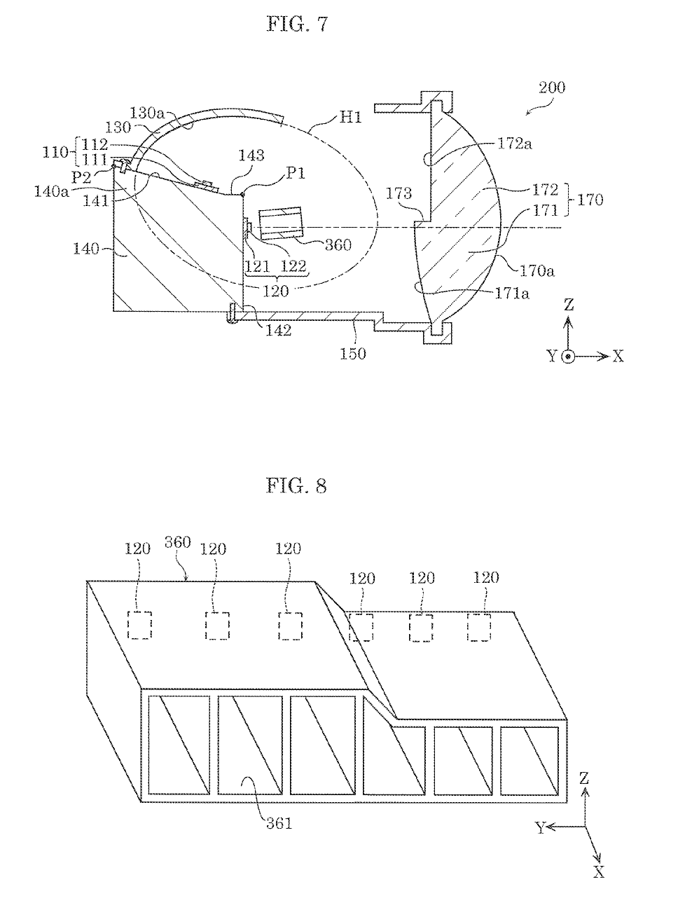

FIG. 7 is a cross-sectional view of moving-body lighting device 200 according to Embodiment 2. FIG. 8 is a perspective view of reflective tube 360 in moving-body lighting device 200 according to Embodiment 2.

This embodiment differs from Embodiment 1 in that moving-body lighting device 200 includes reflective tube 360 disposed on the X axis positive direction side of a plurality of second light sources 120. Unless otherwise stated, moving-body lighting device 200 according to this embodiment has the same configuration as described Embodiment 1. Accordingly, like elements share like reference signs in the drawings, and repeated detailed description of those elements is omitted.

As illustrated in FIG. 7 and FIG. 8, a plurality of second light source 120 are aligned parallel to the Y axis. In this embodiment, second light sources 120 are aligned in a single row, but second light sources 120 may be aligned in two or more rows. In other words, second light source 120 may be arranged in a matrix.

Moving-body lighting device 200 includes reflective tube 360.

Reflective tube 360 is, for example, a tubular frame, and internally reflects light. Reflective tube 360 includes a stepped region on the Z axis positive side so as to give headlight 1 a light distribution pattern that is in accordance with the law. Reflective tube 360 internally includes a plurality of light guide passages 361 that guide the light emitted by second light sources 120 to second lens region 172. Reflective tube 360 includes a plurality of entrance openings on the X axis negative direction side through which light emitted by second light sources 120 enters and a plurality of exit openings on the X axis positive direction side through which light emitted by second light sources 120 exits. The entrance and exit openings correspond one to one, and the entrance openings and second light sources 120 correspond one to one. Note that a plurality of reflective tubes 360—one for each second light source 120—may be provided.

Reflective tube 360 is disposed on the X axis positive direction side of second light source 120, and fixed to holding component 150 in an orientation such that the light emitted by second light sources 120 illuminates a predetermined region. Light guide passages 361 in reflective tube 360 are aligned in a direction parallel to the Y axis. The plurality of light guide passages 361 in reflective tube 360 correspond one to one with the plurality of second light sources 120, and guide the light emitted by the plurality of second light sources 120. In other words, in moving-body lighting device 200 according to this embodiment, a single reflective tube 360 that guides the light emitted by second light sources 120 is provided. Reflective tube 360 can selectively illuminate individual regions with the light emitted by the plurality of second light sources 120.

### (Operational Advantages)

Next, operational advantages of moving-body lighting device 200 according to this embodiment will be described.

As described above, moving-body lighting device 200 according to the present embodiment includes a plurality of second light sources 120.

By including a plurality of second light sources 120, moving-body lighting device 200 can selectively illuminate individual regions.

Moving-body lighting device 200 according to this embodiment further includes reflective tube 360 that guides light emitted by the plurality of second light sources 120. Reflective tube 360 includes a plurality of light guide passages 361 in one-to-one correspondence with the plurality of second light sources 120. The plurality of light guide passages 361 are configured to selectively illuminate individual regions with the light emitted by the plurality of second light sources 120.

As described above, reflective tube 360 includes a plurality of light guide passages 361 that are capable of selectively illuminating individual regions with the light emitted by the plurality of second light sources 120. Accordingly, individual regions can be more accurately selectively illuminated with the light emitted by second light sources 120 corresponding to light guide passages 361.

This embodiment also achieves other operational advantages achieved by Embodiment 1.

### (Other Variations, etc.)

Although the present disclosure has been described based on Embodiments 1 and 2, the present disclosure is not limited to Embodiments 1 and 2.

For example, regarding Embodiment 2, the vehicle may further include a sensor and a controller. In an installation location of the moving-body lighting device in the vehicle, while the vehicle is in motion, the sensor may detect an obstacle such as a person or another vehicle, and output information regarding the detection to the controller. The controller may, based on this information, authorize one or more of the second light sources whose light would illuminate the obstacle. The controller may turn off the authorized one or more second light source. Once the sensor no longer detects the obstacle, the controller may turn back on the turned off one or more second light source. In this way, the vehicle can selectively illuminate individual regions. Note that the sensor described here is, for example, an infrared sensor.

Moreover, regarding Embodiments 1 and 2, a plurality of the first light sources may be provided.

Embodiments arrived at by a person skilled in the art making various modifications to any one of Embodiments 1 and 2 as well as embodiments realized by arbitrarily combining structural components and functions in Embodiments 1 and 2 which do not depart from the essence of the present disclosure are included in the present disclosure.

What is claimed is:

1. A moving-body lighting device configured to be used in a moving body, the moving-body lighting device comprising:
a first light source that emits light;
a second light source that is disposed forward of the first light source and emits light forward;
a reflector in a shape of a segment of a spheroid having a first focal point proximate the first light source and a second focal point, and that reflects the light emitted by the first light source;
a projection lens that is disposed forward of the second light source and receives the light emitted by the first light source and reflected by the reflector; and
a shield disposed between the second light source and the projection lens, proximate the second focal point,
wherein:
the shield includes an edge region including a step, the edge region blocking a portion of the light reflected by the reflector and transmitting a remaining portion of the light to the projection lens,
the projection lens includes a first lens region that receives the light emitted by the first light source and reflected by the reflector, and a second lens region that receives the light emitted by the second light source, and
a major axis of the spheroid is oblique to a horizontal axis in an installation position of the moving-body lighting device in the moving body.

2. The moving-body lighting device according to claim 1, wherein
in the installation position, the second light source is disposed vertically lower than the first light source and vertically higher than the shield.

3. The moving-body lighting device according to claim 1, wherein
in the installation position, the first lens region is disposed vertically below the second lens region and vertically lower than the edge region.

4. The moving-body lighting device according to claim 1, wherein
in the installation position, the following are arranged in listed order from top to bottom, vertically: the first light source, the second light source, the edge region, and a boundary between the second lens region and the first lens region.

5. The moving-body lighting device according to claim 1, wherein
the second light source comprises a plurality of second light sources.

6. The moving-body lighting device according to claim 5, further comprising:
a reflective tube that guides the light emitted by the plurality of second light sources,
wherein the reflective tube includes a plurality of light guide passages in one-to-one correspondence with the plurality of second light sources, the plurality of light guide passages configured to selectively illuminate individual regions with the light emitted by the plurality of second light sources.

7. The moving-body lighting device according to claim 1, further comprising:
a heat dissipator including a first surface on which the first light source is disposed and a second surface on which the second light source is disposed, the heat dissipator being thermally connected to the first light source and the second light source,
wherein:
the heat dissipator includes a first edge at which the first surface and the second surface intersect, and
the second light source is disposed a predetermined distance from the first edge on the second surface.

8. The moving-body lighting device according to claim 1, wherein
in the installation position, a rear end of the reflector is located rearward of and vertically higher than the first light source.

9. The moving-body lighting device according to claim 7, wherein:
the heat dissipator includes a protrusion on the first surface,
the protrusion includes a sloped surface that is oblique to the horizontal axis and slopes downward in a forward direction, and
the first light source is disposed on the sloped surface.

10. The moving-body lighting device according to claim 7, wherein:
the heat dissipator is an approximate cuboid,
the first surface of the heat dissipator includes a second edge across from the first edge, and
a rear end of the reflector is in contact with the second edge.

11. The moving-body lighting device according to claim 9, wherein
the first light source is disposed a predetermined distance from the first edge on the sloped surface.

12. The moving-body lighting device according to claim 1, wherein:
the first light source is disposed proximate the first focal point, and
in the installation position, the first focal point is located vertically higher than the second focal point.

13. The moving-body lighting device according to claim 1, wherein
the edge region is disposed proximate the second focal point.

14. A moving-body lighting device configured to be used in a moving body, the moving-body lighting device comprising:
a first light source that emits light;
a reflector that reflects the light emitted by the first light source;
a second light source that is disposed forward of the first light source and emits light forward;
a projection lens that is disposed forward of the second light source and the reflector, and receives the light emitted by the first light source and reflected by the reflector, and the light emitted by the second light source; and
a shield disposed between the second light source and the projection lens, wherein:
the reflector is in a shape of a segment of a spheroid having a first focal point and a second focal point,
the first light source is disposed proximate the first focal point,
the shield:
is disposed proximate the second focal point; and
includes an edge region including a step, the edge region blocking a portion of the light reflected by the reflector and transmitting a remaining portion of the light to the projection lens,
the projection lens includes a first lens region that receives the light emitted by the first light source and reflected by the reflector, and a second lens region that receives the light emitted by the second light source, and
a major axis of the spheroid intersects a horizontal axis in an installation position of the moving-body lighting device the moving body.

15. A moving body, comprising:
a headlight; and
a moving-body light installed in the headlight, the moving-body light comprising:
a first light source that emits light;
a second light source that is disposed forward of the first light source and emits light forward;
a reflector in a shape of a segment of a spheroid having a first focal point proximate the first light source and a second focal point, and that reflects the light emitted by the first light source;
a projection lens that is disposed forward of the second light source and receives the light emitted by the first light source and reflected by the reflector; and
a shield disposed between the second light source and the projection lens, proximate the second focal point,
wherein:
the shield includes an edge region including a step, the edge region blocking a portion of the light reflected by the reflector and transmitting a remaining portion of the light to the projection lens,
the projection lens includes a first lens region that receives the light emitted by the first light source and reflected by the reflector, and a second lens region that receives the light emitted by the second light source, and
a major axis of the spheroid is oblique to a horizontal axis.
